(19) United States
(12) Patent Application Publication
(10) Pub. No.: US 2005/0273556 A1
(43) Pub. Date: Dec. 8, 2005

(54) Method and system for providing a recommended allocation of data storage space

(75) Inventors: Andrew P. Gellai, Tucson, AZ (US); Jerry L. Coale, Prineville, OR (US)

Correspondence Address: SCULLY, SCOTT, MURPHY, & PRESSER, 400 GARDEN CITY PL, GARDEN CITY, NY, 11530, US

(73) Assignee: INTERNATIONAL BUSINESS MACHINES CORPORATION, ARMONK, NY (US)

(21) Appl. No.: 10/861,807

(22) Filed: Jun. 4, 2004

(51) Int. Cl. G06F 12/00

(52) U.S. Cl. 711/114; 711/170

(57) ABSTRACT

Disclosed are a method and system for providing recommended allocation of data storage facility to a host computer system. The preferred embodiment of the invention utilizes an expert algorithm that provides these recommended allocations based on a programmed evaluation of host system storage and attachment requirements for a specific storage facility physical configuration. This algorithm, referred to as the FBSA algorithm, provides recommended setup options for fixed block storage allocations to host system attachment. A performance requirements evaluation is based on a cumulative rating of several performance related configuration factors that describe a storage facility and how a host system application is expected to access its allocated storage. Recommendation accuracy is gauged according to the availability of configuration factor information.

### REFERENCE TO RELATED APPLICATION

This application is related to the disclosure of copending application no. ______ (Attorney Docket TUC920030117US1), for “A Method And System For Providing Recommended Options For A Host Computer System Attachment To Data Storage Facility Adapter Ports,” filed herewith, the disclosure of which is herein incorporated by reference in its entirety.

### BACKGROUND OF THE INVENTION

1. Field of the Invention

This invention generally relates to the allocation of data storage space in a computer system. More specifically, the invention relates to a method and system for providing a recommended allocation of data storage space in a computer system having a plurality of host computers and a data storage facility.

2. Background Art

As it is known in the art, computer systems generally include a central processing unit, a memory subsystem and a storage subsystem. According to a networked or enterprise model of a computer system, the storage subsystem associated with or in addition to a local computer system, may include a large number of independent storage devices or disks housed in a single enclosure. This array of storage devices is typically connected to several computers (or hosts) via dedicated cabling or via a network. Such a model allows for the centralization of data that is to be shared among many users and also allows a single point of maintenance for the storage functions associated with the many computer systems.

One type of storage system known in the art includes a number of disk storage devices, configured as an array. Such a system may include several arrays of storage devices. In addition to the arrays of storage devices, typical storage systems include several types of controllers for controlling the various aspects of the data transfers associated with the storage system. One type of controller is a host controller and provides the interface between the host computers and the storage system. Another type of controller is a disk controller that is used to manage the transfer of data to and from an associated array of storage devices (e.g. disk drives). There may be one or more disk controllers for each array of storage devices in a storage system.

One difficult challenge that is faced when computer systems are set up is to determine how best to allocate the data storage space to the host computers. Current host system attachment to storage facility configuration planning processes are largely dependent on storage specialists, their learned expertise and on a configuration planner document that contains a large number of worksheets. A storage specialist will evaluate a customer's system attachment requirements and fill out a set of configuration planner worksheets that are used during storage facility installation at a customer's business site to guide a manual process for applying storage facility configuration settings.

A storage facility is not available for customer evaluation and production use until after the storage facility configuration processes are complete. Usually, a customer is satisfied with the final configuration results. However, there are occasions where customer expectations are not satisfied and steps must be taken to alter configuration settings, a process that may take many additional hours to complete.

### SUMMARY OF THE INVENTION

An object of this invention is to improve procedures for the allocation of storage space in a data storage facility to host systems that use that storage facility.

Another object of the present invention is to provide a method and system to arrive at an expert quality recommendation for open systems type host system attachment storage allocations.

A further object of the invention is to evaluate the data access performance requirements for a host system attachment and to produce a recommendation to configure the storage space that will be assigned to host system attachment logical unit numbers (LUNs).

The present invention attains these and other objectives by use of an expert algorithm that provides recommended setup options for fixed block storage allocations to host system attachment. The preferred embodiment of the invention utilizes an expert algorithm that provides these recommended setup options based on a programmed evaluation of host system storage and attachment requirements for a specific storage facility physical configuration. The preferred expert algorithm provides recommended setup options for fixed block storage allocations (FBSA) to host system attachment, and this algorithm is thus referred to as the FBSA algorithm. This algorithm can be implemented, for example, in the IBM Total Storage ESS (Enterprise Storage System) Initial Setup Assistant (ISA) tool.

The FBSA algorithm evaluates the data access performance requirements for a host system attachment and produces a recommendation to configure the data storage disk arrays and fixed block volumes that will be assigned to host system attachment logical unit numbers (LUNs). A performance requirements evaluation is based on a cumulative rating of several performance related configuration factors that describe a storage facility and how a host system application is expected to access its allocated storage. Recommendation accuracy is gauged according to the availability of configuration factor information. When information is unavailable or unknown, the FBSA algorithm defaults to a mid-scale evaluation that favors good, but not critical, data access performance.

Configuration factors used by the FBSA algorithm that concern host system attachment characteristics and storage requirements may be manually input via the ISA tool UI, or the ISA tool may inter operate with another software application to query a database containing host system profile information for an enterprise complex. Availability of an external database source is dependent on the ISA software application installation environment and application setup to enable inter operation with other compatible software applications. Software applications, other than the ISA tool, are not described by this disclosure. Configuration factors used by the FBSA algorithm that concern a storage facility physical configuration features may be uploaded from an installed storage facility, imported from a storage facility purchase order program, or they may be manually input via the ISA tool UI.

A FBSA algorithm generated recommendation is presented to the ISA tool UI as part of the open systems storage configuration process. The purpose for providing a recommendation is to assist the user with making complex choices that would otherwise require expert knowledge about storage facility internal operations. However, preferably, the user makes the final choice for host system attachment storage allocations.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a block diagram of a computer system including a mass storage system and with which the present invention may be used.

FIG. 2 is a flow chart showing a procedure for implementing this invention.

### DETAILED DESCRIPTION OF THE PREFERRED EMBODIMENTS

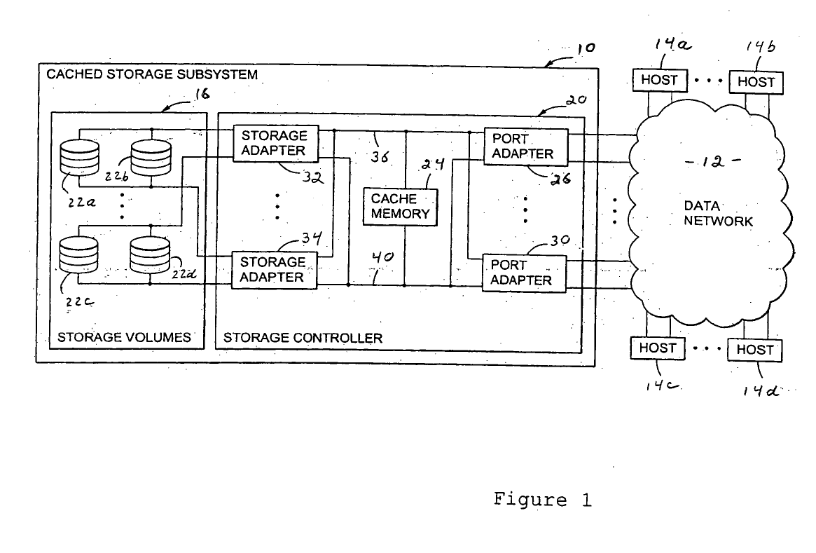

With reference to FIG. 1 of the drawings, there is shown a cached storage facility 10 connected via a data network 12 to a plurality of hosts 14a, 14b, 14c and 14d. The cached storage subsystem 10 includes storage volumes 16 and a storage controller 20 for controlling access of the hosts to the storage volumes. The storage volumes are logical units of storage distributed over one or more storage devices 22a, 22b, 22c and 22d. The storage devices may be magnetic disk drives, optical disk drives, tape drives, solid-state memory devices, or other storage devices capable of providing nonvolatile data storage. Presently, the preferred storage devices are magnetic disk drives. For instance, these disks may be arranged in a manner well known in the art and referred to as a redundant array of independent disks (RAID).

The storage controller 20 includes a dual port cache memory 24, a plurality of port adapters 26 and 30, and a plurality of storage adapters 32 and 34. The cache memory 24 is accessed via any one of two back-plane busses 36 and 40. Each of the storage adapters 32 and 34 links a respective set of the storage devices to each of the two back-plane busses. For example, the cached storage subsystem includes up to eight storage adapters and up to eight port adapters, and each port adapter provides two independent data ports to the data network. Preferably, in a known manner, storge volumes 16 are separated into logical subsystems (LSSs).

The host computers may each be any of a well-known type of computer system. For example, host 14a may be a mainframe computer or may be an open system computer or alternatively may be a personal computer. Each of the computer systems just mentioned typically communicates using a special communications protocol. For instance, one host system may communicate using a Small Computer System Interface (SCSI), and another host computer may use a fibre channel communication protocol.

During operation, a host computer may desire to read data from or write data to one of the disk arrays contained within the storage facility 10. In order to do so, the host computer would send a request over its associated bus to the controller attached to that bus. The controller, once it receives the request from the host computer, begins performing those tasks necessary to satisfy the request. In this operation, the storage servers and storage adapters tend to be the actual performance bottlenecks. If all volumes are on disk drives associated with one storage adapter on one storage server, then performance will be significantly worse than if the volumes were split between the two servers and then further split among the four storage adapters in each server.

The present invention provides a procedure for recommending storage allocation for the host computer systems in the data storage facility. In its preferred implementation, the invention provides recommended set up options for fixed block storage allocations (FBSA) to host system attachment.

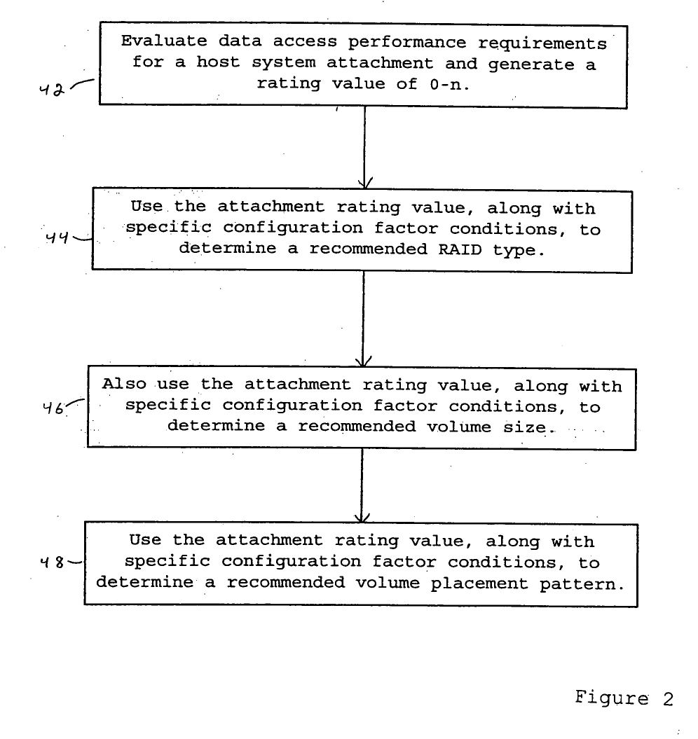

With reference to FIG. 2, the FBSA algorithm executes a four step process to arrive at a configuration setup recommendation. The first step 42 evaluates the data access performance requirement for a host system attachment and generates a rating value of O-n. The second step 44 uses the attachment rating value developed at step 42, along with specific configuration factor conditions, to determine a recommended RAID type. Step 46 also uses the attachment rating value along with specific configuration factor conditions to determine a recommended volume size. Step 48 uses the attachment rating value along with specific configuration factor conditions to determine a recommended volume placement pattern in storage facility logical subsystems (LSSes), and then uses accumulated LSS attachment rating values to determine the specific set of LSSes that should contain the current host system attachment volumes.

In preparation for the FBSA algorithm, the ISA tool allows the user to define individual ESS units and host systems and to specify attachments between the ESS units and the host systems. For each attachment being configured between an ESS unit and a host system, the ISA tool allows the user the option of providing performance information on the data that is to traverse on the attachment. The user-provided performance data is based on the user's own observations/experience with the host system's data access requirements based on applications runng on the host system. If the user chooses not to provide the data, then the “normal” data access performance level will be assumed. Optionally, the performance information can be input to the ISA tool from other performance analysis/advisor tools (such as ESS Expert).

The preferred performance data is comprised of twelve performance factors. Each performance factor yields a rating of 0-2. A rating of “0” indicates that data access performance for an attachment is “not critical.” A rating of “1” indicates that the performance requirement is “normal,” and a rating of “2” indicates that the performance requirement is “critical.” Greater rating scale granularity could be achieved with additional performance factors, or with additional rating points for any or all factors. The factors used by the ISA tool to rate the performance requirement for an attachment are listed below.

ReadTransactionType[Sequential=0][MixedUnknown=1][Random=2]WriteTransactionType[Sequential=0][MixedUnknown=1][Random=2]ReadTransactionFrequency [Seldom=0][MixedUnknown=1][Frequent=2]WriteTransactionFrequency[Seldom=0][MixedUnknown 1][Frequent=2]ReadXferSize [Small=0][ModerateUnknown=1][Large=2]WriteXferSize [Small=0][ModerateUnknown=1][Large=2]ReadCacheRatio [High=0][ModerateUnknown=1][Low=2]WriteCacheRatio [High=0] [ModerateUnknown=1][Low=2]ResponseTime [NotCritical=0][ModerateUnknown=1][Critical=2]NumberUsers [Few=0][ModerateUnknown=1][Many=2]NumberInitiators [Few=0][ModerateUnknown=1][Many=2]NumberLuns [Few=0][ModerateUnknown=1][Many=2].

A middle scale value is chosen by default for any factor that cannot be resolved from specific input information.

With reference again to FIG. 2, in response to the user-provided performance data, the FBSA algorithm step 42 process generates a data access performance requirement rating for the current attachment. The data access performance requirement for each host system attachment to a storage facility is rated on a scale of 0-n according to the cumulative evaluation of several data access performance factors. A rating of “0” indicates that data access performance for an attachment is not critical. A rating of “1-n” indicates a greater performance requirement, up to the point where fast data access is critical for each transaction from an attachment that has a very high and random transaction rate.

The twelve performance factors listed previously allow for a cumulative performance rating scale of 0-24. This data access performance requirement rating is developed by the ISA tool for use by several configuration setup recommendation algorithms, including the FBSA algorithm. For example, as described in the above-identified application no. ______ (Attorney Docket TUC920030117US1), this rating may also be used to provide recommended options for the selection of the storage facility's I/O ports that are to be assigned for transmission of data between the host system and the facility's I/O ports. The data access performance requirement rating for a host system attachment is most accurate when information about all factors is available.

The FBSA algorithm step 44 process recommends the RAID array type for host system attachment volumes. The RAID array type recommendation is based on a host attachment performance requirement rating or the specific condition of certain configuration factors. The default RAID array type recommendation for any attachment is RAID 5. The alternative array type recommendation is RAID 10. The FBSA algorithm is programmed to recommend the RAID 10 array type if a host attachment performance requirement rating is equal to or greater than 63% of scale, or if all of the following configuration factors are true:
TransactionType=[Random=2],
TransactionFrequency=[Frequent=2], and
ResponseTime=[Critical=2].

The FBSA algorithm step 46 process recommends a volume size for host system attachment volumes. The volume size recommendation is based on a host attachment performance requirement rating, and according to the following rule set: If attachment rating is =>66% of scale and if the storage facility contains 36 GB and or 72 GB (or larger) capacity disk packs, then recommend a 16 GB volume size. Otherwise, if attachment rating is =>66% of scale, recommend a 8 GB volume size. If attachment rating is =>33% and <66% of scale and if the storage facility contains 36 GB and or 72 GB (or larger) capacity disk packs, then recommend a 32 GB volume size. Otherwise, if attachment rating is =>33% and <66% of scale, recommend a 24 GB volume size. If attachment rating is <33% of scale and if the storage facility contains 36 GB and or 72 GB (or larger) capacity disk packs, then recommend a 64 GB volume size. Otherwise, if attachment rating is <33% of scale, recommend a 40 GB volume size. It may be noted that in the particular storage server disclosed herein, volume size is a performance factor. In other versions of storage servers, volume size may not be a performance factor.

The FBSA algorithm step 48 process recommends a volume placement pattern for host system attachment volumes. The volume placement pattern recommendation is based on a host attachment performance requirement rating or the specific condition of certain configuration factors. The default volume placement pattern recommendation for any attachment is to spread the volumes across as many LSSes as possible, with preferred assignment to LSSes with the lowest expected workload. The FBSA algorithm attempts to balance the work load allocations to all LSSes. This is done by accumulating the performance requirement ratings for each host system assignment to individual LSSes, and then by making new assignments to those LSSes with the lowest accumulation of rating values.

An alternative placement pattern recommendation, at step 48, is to sequentially assign volumes to LSS storage, using as few LSSes as possible. The FBSA algorithm is programmed to recommend the sequential LSS placement pattern if a host attachment performance requirement rating is equal to or less than 33% of scale, or if all of the following configuration factors are true:
TransactionType=[Sequential=0],
ResponseTime=[NotCritical=0], and
NumberUsers=[Few=0].

With the ISA tool recommendations, preferably, the user makes the final choice for host system attachment storage allocations. However, the ISA tool maintains and displays the performance requirement rating accumulation for each storage array so that each new assignment, whether resulting from a FBSA algorithm recommendation or from user selection, may be based on an effort to balance the array access workloads for all host system attachments. As each storage array may contain volumes assigned to multiple host attachments, the ISA tool can show a table of storage arrays. For each storage array, the table shows their volumes and the volumes' associated host attachments and the cumulative performance rating for the associated host attachments.

In addition, the ISA tool can show a graphic showing the storage facility ports and the storage facility arrays. Each array is highlighted by the color green, yellow or red, to indicate low, moderate or heavy loading on the array access by the host attachments. When the user clicks on an array, the ports through which the array's attachments are routed are also highlighted. With the table and the graphic, the user can review the array and volume allocations and host attachments, with the option of modifying the volume assignments in an effort to more evenly distribute the array access workload among all arrays and to eliminate the “red spots.”

It may be noted that, in one embodiment of the invention, each LSS may be permanently associated with a storage adapter on one server. There are sixteen LSSs, two for each storage adapter, and eight LSSs for each server. With this arrangement, referring to distributing the volumes among the LSSs, also means distributing the volumes among the servers and storage adapters.

However, in another version of the storage subsystem, each LSS might not necessarily be permanently associated with a storage adapter. There might be no fixed distribution of the LSSs among the storage adapters. With this arrangement, instead of distributing the volumes among the LSSs, the volumes are distributed among the servers and storage adapters.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of providing a recommended allocation of data storage space, in a data storage facility, to a host computer system, the method comprising the steps of:
providing a data access performance requirements evaluation based on a cumulative rating of a given set of data access performance related factors; and
determining a recommended allocation of data storage space, using said evaluation, for the host computer system.

2. A method according to claim 1, wherein:
the step of providing a data access performance requirement evaluation includes the step of generating a rating value of O-n; and
the step of determining a recommended allocation of data storage space includes the step of using said rating value, along with specific configuration factor conditions, to determine the recommended allocation of data storage space.

3. A method according to claim 1, wherein the step of determining the recommended allocation includes the step of using said evaluation to determine a recommended volume size.

4. A method according to claim 1, wherein the step of determining the recommended allocation includes the step of using said evaluation to determine a recommended volume placement pattern.

5. A method according to claim 1, wherein the data storage facility includes a multitude of storage facility logical subsystems, and the determining step includes the step of determining a specific set of logical subsystems that should be assigned to contain data from the host computer system.

6. A method according to claim 1, wherein the data storage facility includes a group of different types of redundant arrays of independent disks (RAIDs), and the determining step includes the step of determining one of said RAID types to store data from the host computer system.

7. A method according to claim 1, wherein the data storage facility includes a multitude of storage facility logical subsystems, and wherein:
the step of providing a data access performance requirement evaluation includes the step of generating a rating value of o-n; and
the step of determining a recommended allocation includes the step of, if said rating value is below a given value, sequentially assigning logical subsystems of the data storage facility to the host computer system.

8. A system for providing a recommended allocation of data storage space, in a data storage facility, to a host computer system, the system comprising:
means for providing a data access performance requirements evaluation based on a cumulative rating of a given set of data access performance related factors; and
means for determining a recommended allocation of data storage space, using said evaluation, for the host computer system.

9. A system according to claim 8, wherein:
the means for providing a data access performance requirement evaluation includes means for generating a rating value of O-n; and
the means for determining a recommended allocation of data storage space includes means for using said rating value, along with specific configuration factor conditions, to determine the recommended allocation of data storage space.

10. A system according to claim 8, wherein the means for determining the recommended allocation includes means for using said evaluation to determine a recommended volume size.

11. A system according to claim 8, wherein the means for determining the recommended allocation includes means for using said evaluation to determine a recommended volume placement pattern.

12. A system according to claim 8, wherein the data storage facility includes a multitude of storage facility logical subsystems, and the means for determining step includes means for determining a specific set of logical subsystems that should be assigned to contain data from the host computer system.

13. A system according to claim 8, wherein the data storage facility includes a group of different types of redundant arrays of independent disks (RAIDs), and the means for determining includes means for determining one of said RAID types to store data from the host computer system.

14. A program storage device readable by machine, tangibly embodying a program of instructions executable by the machine to perform method steps for providing a recommended allocation of data storage space, in a data storage facility, to a host computer system, said method steps comprising:
providing a data access performance requirements evaluation based on a cumulative rating of a given set of data access performance related factors; and
determining a recommended allocation of data storage space, using said evaluation, for the host computer system.

15. A program storage device according to claim 14, wherein:
the step of providing a data access performance requirement evaluation includes the step of generating a rating value of O-n; and
the step of determining a recommended allocation of data storage space includes the step of using said rating value, along with specific configuration factor conditions, to determine the recommended allocation of data storage space.

16. A program storage device according to claim 14, wherein the step of determining the recommended allocation includes the step of using said evaluation to determine a recommended volume size.

17. A program storage device according to claim 14, wherein the step of determining the recommended allocation includes the step of using said evaluation to determine a recommended volume placement pattern.

18. A program storage device according to claim 14, wherein the data storage facility includes a multitude of storage facility logical subsystems, and the determining step includes the step of determining a specific set of logical subsystems that should be assigned to contain data from the host computer system.

19. A program storage device according to claim 14, wherein the data storage facility includes a group of different types of redundant arrays of independent disks (RAIDs), and the determining step includes the step of determining one of said RAID types to store data from the host computer system.
